(19) United States
(12) Patent Application Publication
(10) Pub. No.: US 2011/0173036 A1
(43) Pub. Date: Jul. 14, 2011

(54) ENVIRONMENTAL BURDEN INDICATING APPARATUS AND COMPUTER READABLE MEDIUM THEREOF

(75) Inventors: Manabu UEDA, Yokohama-shi (JP); Yuichi UENO, Yokohama-shi (JP)

(73) Assignee: FUJI XEROX CO., LTD., Tokyo (JP)

(21) Appl. No.: 12/942,075

(22) Filed: Nov. 9, 2010

(30) Foreign Application Priority Data
Nov. 9, 2009 (JP) 2009-256471

(51) Int. Cl. G06Q 10/00

(52) U.S. Cl. 705/7.11

(57) ABSTRACT

An environmental burden indicating apparatus includes a first history acquiring unit that acquires history of positional information which indicates position of at least one user, wherein the history of the positional information corresponds to first time information, and a second history acquiring unit that acquires history of environmental burden information which indicates the amount of burden against an environment produced in a facility where the at least one user is positioned, wherein the history of the environmental burden information corresponds to second time information. The environmental burden indicating apparatus further includes a environmental burden calculation unit that calculates personal environmental burden information of each user after allocating the environmental burden information acquired from the facility into each user based on the positional information; and a environmental burden indicator unit that indicates the personal environmental burden information of the at least one users.

### CROSS-REFERENCE TO RELATED APPLICATION

This application is based on and claims priority under 35 USC 119 from Japanese Patent Application No. 2009-256471 filed on Nov. 9, 2009.

### BACKGROUND

### Technical Field

The present invention relates to an environmental burden indicating apparatus and a computer readable medium thereof.

### SUMMARY

According to an aspect of the invention, an environmental burden indicating apparatus includes a first history acquiring unit that acquires history of positional information which indicates position of at least one user, wherein the history of the positional information corresponds to first time information; a second history acquiring unit that acquires history of environmental burden information which indicates the amount of burden against an environment produced in a facility where the at least one user is positioned, wherein the history of the environmental burden information corresponds to second time information; a environmental burden calculation unit that calculates personal environmental burden information of each user after allocating the environmental burden information acquired from the facility into each user based on one or more of the positional information, the first time information and second time information; and a environmental burden indicator unit that indicates the personal environmental burden information of the at least one user.

### BRIEF DESCRIPTION OF THE DRAWINGS

Embodiments of the invention will be described in detail based on the following figures;

FIG. 1 is a schematic drawing to show a configuration example of an environmental burden indicating system according to an embodiment of the invention;

FIG. 2 is a schematic drawing to show a configuration example of an environmental burden indicating server;

FIG. 3 is a schematic drawing to show a configuration example of a position information history table;

FIG. 4 is a schematic drawing to show a configuration example of environmental burden information;

FIG. 5 is a schematic drawing to show a configuration example of personal environmental burden information;

FIG. 6 is a schematic drawing to show a configuration example of organization attribute information;

FIG. 7 is a schematic drawing to show a configuration example of organization environmental load information;

FIG. 8 is a schematic drawing to show a configuration example of environmental burden indicating information;

FIG. 9 is a schematic drawing to show a configuration example of environmental burden indicating information;

FIG. 10 is a schematic drawing to show a configuration example of environmental burden indicating information;

FIG. 11 is a schematic drawing to show a configuration example of environmental burden indicating information;

FIG. 12 is a flowchart to show an operation example of the environmental burden indicating server; and

FIG. 13 is a flowchart to show another operation example of the environmental burden indicating server.

### DETAILED DESCRIPTION

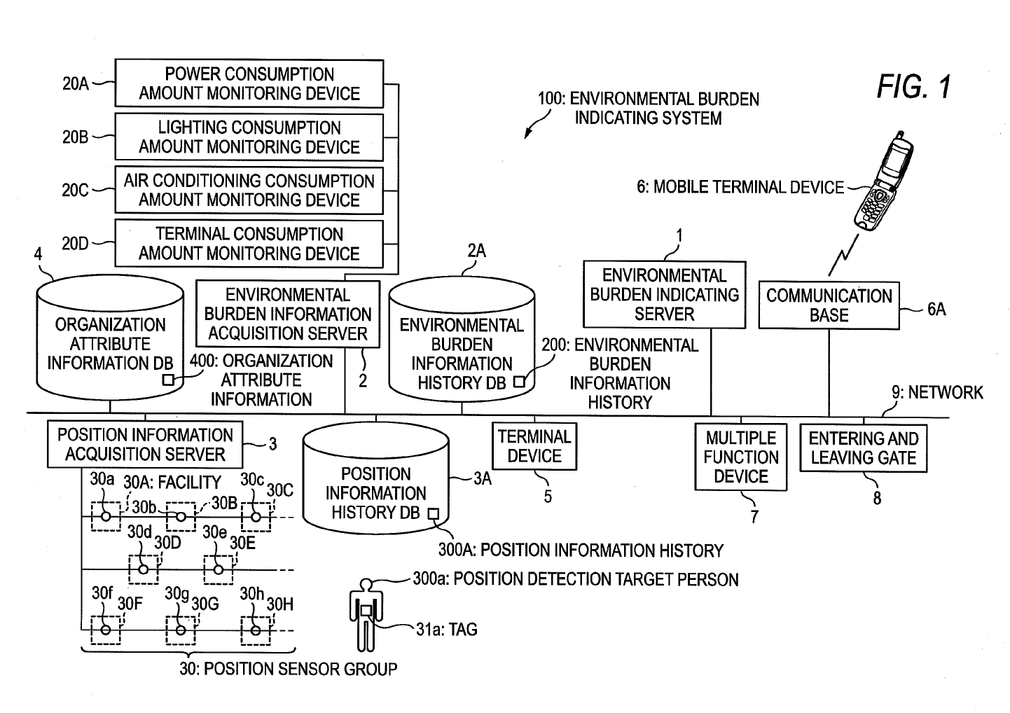

(Configuration of environmental burden indicating system) FIG. 1 is a schematic drawing to show a configuration example of an environmental burden indicating system according to an embodiment of the invention.

An environmental burden indicating system 100 has an environmental burden indicating server 1, an environmental burden information acquisition server 2, an environmental burden information history database (DB) 2A, a position information acquisition server 3, a position information history DB 3A, an organization attribute information DB 4, a terminal device 5, a mobile terminal device 6, a multiple function device 7, an entering and leaving gate 8, and a network 9 for connecting the sections so that they can communicate with each other.

The environmental burden indicating server 1 acquires information concerning environmental burdens of facilities 30A to 3011 described later used by registered users (hereinafter, called “environmental burden information”), allocates the acquired environmental burden information for each user, calculates information concerning environmental burdens on the whole organization to which each user belongs and for each user, and indicates the information to the user. In the embodiment, the “environmental burden” refers to burden given to the environment and, for example, is the CO₂ emission amount into which the power consumption amount, etc., is converted; however, the power consumption amount may be used simply or the burden may be replaced with any other value of running water consumption, gas consumption, etc.

The environmental burden information acquisition server 2 acquires environmental burden information of facilities 30A to 30H, acquires environmental burden information from a power consumption amount monitoring device 20A for monitoring the consumption amount of power consumed using receptacles installed in the facility for each of the facilities 30A to 30H, a lighting consumption amount monitoring device 20B for monitoring the power consumption amount of lighting for each of the facilities 30A to 30H, an air conditioning consumption amount monitoring device 20C for monitoring the power consumption amount of air conditioning for each of the facilities 30A to 30H, a terminal device consumption amount monitoring device 20D for each terminal device used by the user, totalizes the information, and calculates the environmental burden information for each facility. The environmental burden information acquisition server 2 also creates and outputs environmental burden indicating information to indicate the information to the user from the environmental burden information.

The environmental burden information acquisition server 2 may acquire, for example, consumption of gas or running water as environmental burden information from any other type of monitoring device in addition to the power consumption amount. The power consumption amount monitoring device 20A, the lighting consumption amount monitoring device 20B, the air conditioning consumption amount monitoring device 20C, and the terminal device consumption amount monitoring device 20D may measure the consumption amounts in real time and output environmental burden information or may estimate and output environmental burden information from predetermined information.

When environmental burden information is estimated and is output from predetermined information and, for example, only the total consumption amount of the whole floor can be calculated and the floor is divided into areas, the environmental burden information is output in such a manner that the total consumption amount is allocated in response to the occupation area of the division area. If the monthly or yearly power consumption only can be calculated, the consumption amount is allocated daily, hourly, etc.

The environmental burden information acquired by the environmental burden information acquisition server 2 is stored in the environmental burden information history DB 2A as an environmental burden information history 200 together with time information.

The term “facility” is a space area of an office, a conference room, an open space, a lobby, a warehouse, etc.

The position information acquisition server 3 acquires the position where a position detection target person 300a (user) having a tag 31a exists at regular time intervals, for example, at intervals of three seconds by a position sensor group 30 made up of position sensors 30a to 30h placed in a one-to-one correspondence with the facilities 30A to 30H. A history of the acquired position information of the position detection target person 300a is stored in the position information history database (DB) 3A as a position information history 300A. A position detection unit can use RFID (Radio Frequency Identification), Bluetooth (registered trademark), a wireless LAN (Local Area Network), etc., as a detecting unit in real time. A system in which history information of facility use is stored, for example, a conference room reservation system, an entering and leaving gate system, etc., can be used as a detecting unit in non-real time.

The organization attribute information DB 4 stores organization attribute information 400 indicating the department, the type of occupation, the duty, etc., of the user.

The terminal device 5 is a device for communicating with the environmental burden indicating server 1 and displaying environmental burden indicating information output by the environmental burden indicating server 1 and has an operation section for operation input, a display section of a liquid crystal display, etc., and a control section including electronic components of a CPU (Central Processing Unit), a storage section, etc. The terminal device 5 may be, for example, a personal computer, a PDA (Personal Digital Assistant), etc. One terminal device 5 is shown in the figure, but two or more terminal devices may exist.

Like the terminal device 5, the mobile terminal device 6 is a device for displaying environmental burden indicating information and receives the environmental burden indicating information by communicating with a communication base 6A by radio, for example, by mail, etc.

The multiple function device 7 is a device mainly including the functions of a printer, a FAX machine, a scanner, etc., and includes a display section of a liquid crystal display, etc.; for example, when the user uses the functions, the multiple function device 7 displays the environmental burden indicating information on the display section.

The entering and leaving gate 8 is a gate installed in a gateway of a building having the facility and monitoring passage of the user; for example, when the user passes through the gate, the environmental burden indicating information for the user is indicated by a beep sound, music of a melody sound, etc.

The network 9 may be a LAN, the Internet, etc., and may be wired or wireless.

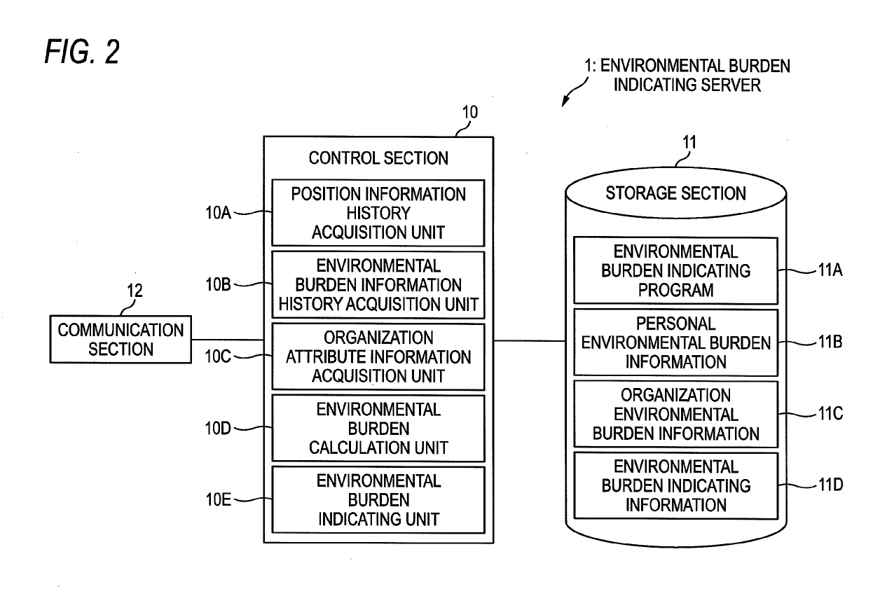

FIG. 2 is a schematic drawing to show a configuration example of the environmental burden indicating server 1. The environmental burden indicating server 1 has a control section 10 made up of a CPU, etc., for controlling the sections and executing various programs, a storage section 11 made up of storage devices of an HDD (Hard Disk Drive), flash memory, etc., for storing information, and a communication section 12 for communicating with the outside through the network 9.

The control section 10 executes an environmental burden indicating program 11A described later, thereby operating as a position information history acquisition unit 10A, an environmental burden information history acquisition unit 10B, an organization attribute information acquisition unit 10C, an environmental burden calculation unit 10D, and an environmental burden indicating unit 10E.

The position information history acquisition unit 10A acquires a position information history 300A from the position information history DB 3A.

The environmental burden information history acquisition unit 10B acquires a history of environmental burden information for each of the facilities 30A to 30H from the environmental burden information acquisition server 2.

The organization attribute information acquisition unit 10C acquires organization attribute information 400 from the organization attribute information DB 4.

The environmental burden calculation unit 10D identifies the user using the facility from the position information history 300A, allocates the environmental burden information for each of the facilities 30A to 30H acquired by the environmental burden information history acquisition unit 10B to the user using the facility, calculates the environmental burden information of the user, and outputs the information as personal environmental burden information 11B. The environmental burden calculation unit 10D calculates the environmental burden of the whole organization to which the user belongs and outputs the burden as organization environmental burden information 11C. The environmental burden calculation unit 10D calculates statistical information of average, total, difference, deviation, etc., for example, from the personal environmental burden information 11B and the organization environmental burden information 11C in response to a request of the environmental burden indicating unit 10E described below.

The environmental burden indicating unit 10E generates text information of a message, etc., image information of a graph, etc., print information, or sound information of a beep sound, etc., from the personal environmental burden information 11B, the organization environmental burden information 11C, and their statistical information, and outputs the information as environmental burden indicating information 11D.

The storage section 11 stores an environmental burden indicating program 11A for causing the control section 10 to operate as the units described above, the personal environmental burden information 11B output by the environmental burden calculation unit 10D, and the environmental burden indicating information 11D output by the environmental burden indicating unit 10E.

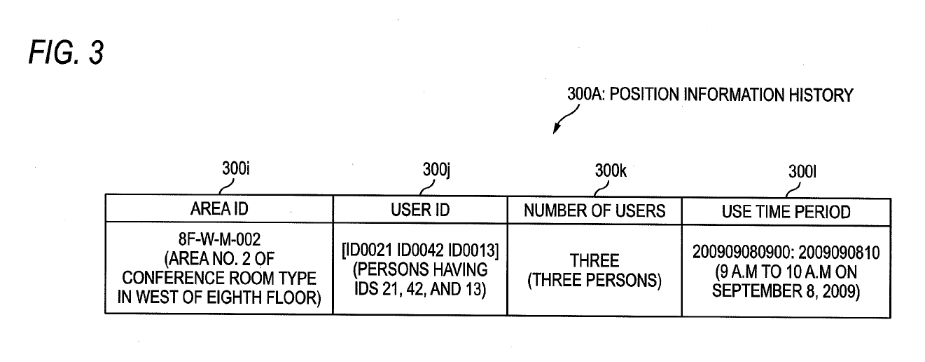

FIG. 3 is a schematic drawing to show a configuration example of the position information history 300A. The position information history 300A has an area ID column 300i indicating identification information of the facilities 30A to 3011, a user ID column 300j indicating the identification information of the user existing in the facility, a number-of-users 300k indicating the number of existing users, and a use time period column 300l indicating the time period over which the facility was used. The example shown in FIG. 3 indicates a history in which three persons with user IDs 21, 42, and 13 exist from 9 a.m to 10 a.m on Sep. 8, 2009 in area No. 2 of conference room type in the west of the eighth floor.

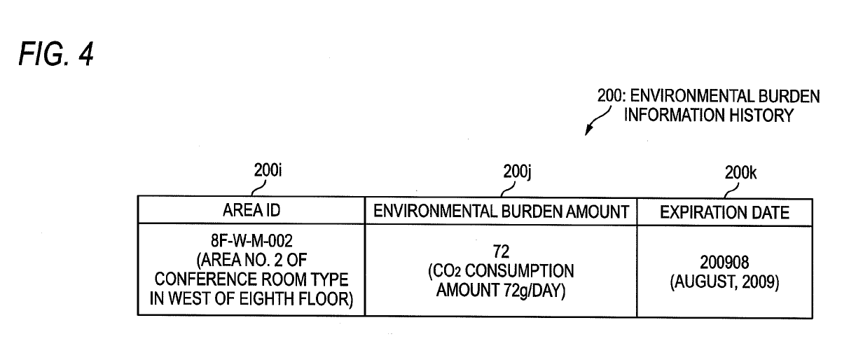

FIG. 4 is a schematic drawing to show a configuration example of the environmental burden information history 200. The environmental burden information history 200 is an example wherein environment burdens of the facilities 30A to 30H are not measured in real time and the environmental burden amount is previously determined, and has an area ID column 200i indicating identification information of the facilities 30A to 30H, a predetermined environmental burden amount column 200j, and an expiration date column 200k indicating the expiration date until which the environmental burden information can be used. A plurality of types of environmental burden information history 200 may be provided by combining the time zone, the location of each user, the number of persons, a meteorological condition, etc. The environmental burden information history 200 may be changed for each season classified by setting of the air conditioning temperature, etc.

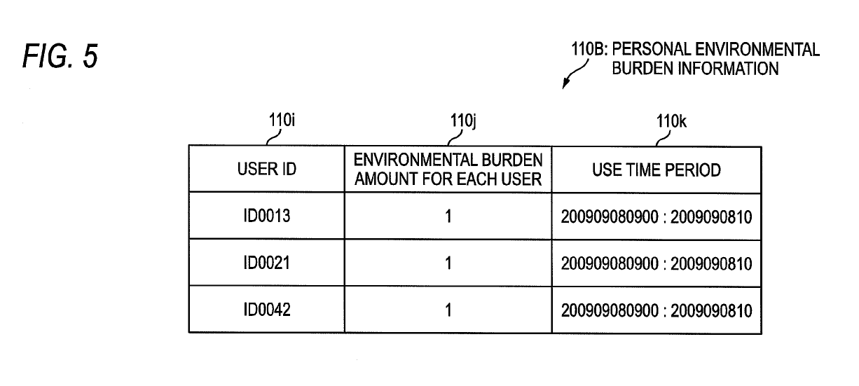

FIG. 5 is a schematic drawing to show a configuration example of the personal environmental burden information 11B. The personal environmental burden information 110B is an example of the personal environmental burden information 11B for each user calculated from the position information history 300A shown in FIG. 3 and the environmental burden information history 200, and has a user ID column 110i indicating identification information of the user, an environmental burden amount column 110j for each user calculated for each user, and a use time period 110k indicating the time period to which the calculated environmental burden amount belongs.

In the example shown in FIG. 5, the amount is calculated in the case where a facility whose environmental burden amount per day is 72 g is used for one hour by three persons; the environmental burden amount per person is 72 (g)×1/24 (hours)÷ three (persons)=1 (g/person) and is allocated to each user. As methods of simplifying the environmental burden amount and the environmental burden amount per person, for example, the environmental burden amount may be displayed as a level in such a manner that when the CO₂ emission amount per day is 0 g to 100 g, level 1 is set, when the CO₂ emission amount per day is 101 g to 200 g, level 2 is set, when the CO₂ emission amount per day is 201 g to 300 g, level 3 is set, when the CO₂ emission amount per day is 301 g to 400 g, level 4 is set, and when the CO₂ emission amount per day is 401 g or more, level 5 is set; the environmental burden amount per person may be displayed as points in such a manner that when the amount is 0 g/person to 10 g/person, one point is set, when the amount is 11 g/person to 20 g/person, two points are set, when the amount is 21 g/person to 30 g/person, three points are set, when the amount is 31 g/person to 40 g/person, four points are set, and when the amount is 41 g/person or more, five points are set.

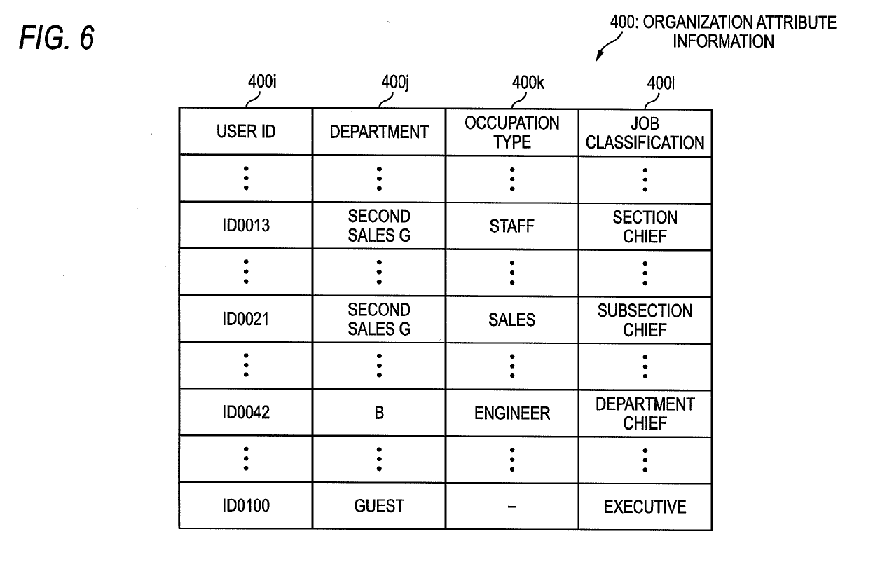

FIG. 6 is a schematic drawing to show a configuration example of the organization attribute information 400. The organization attribute information 400 is information indicating the attributes of each user in the organization and has a user ID column 400i indicating identification information of the user, a department column 400j indicating the department to which the user belongs, an occupation type column 400k indicating the occupation type of the user, and a job classification column 400l indicating the job classification of the user.

User “ID0100” indicates a guest, a dispatched employee, etc., whose department contained in the organization attribute information is “Guest” and who does not belong to an organization; environmental burden is not allocated or is lightened.

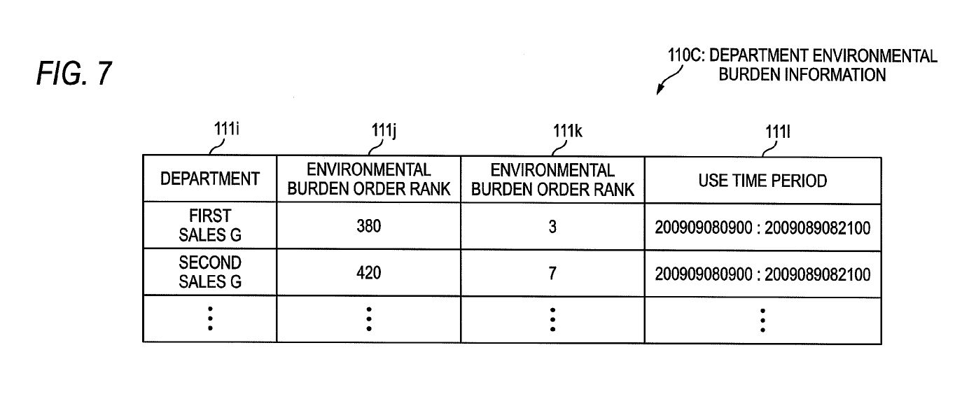

FIG. 7 is a schematic drawing to show a configuration example of organization environmental burden information 11C. Department environmental burden information 111C is information provided by calculating the environmental burden for each department as an example of the organization environmental burden information 11C and has a department column 111i indicating identification information of the department, an environmental burden average column 111j indicating the average of the environmental burden of the whole department, an environmental burden order rank column 111k indicating the order rank of the environmental burden average of the department in the whole organization, and a use time period column 111l indicating the time period over which calculation is performed.

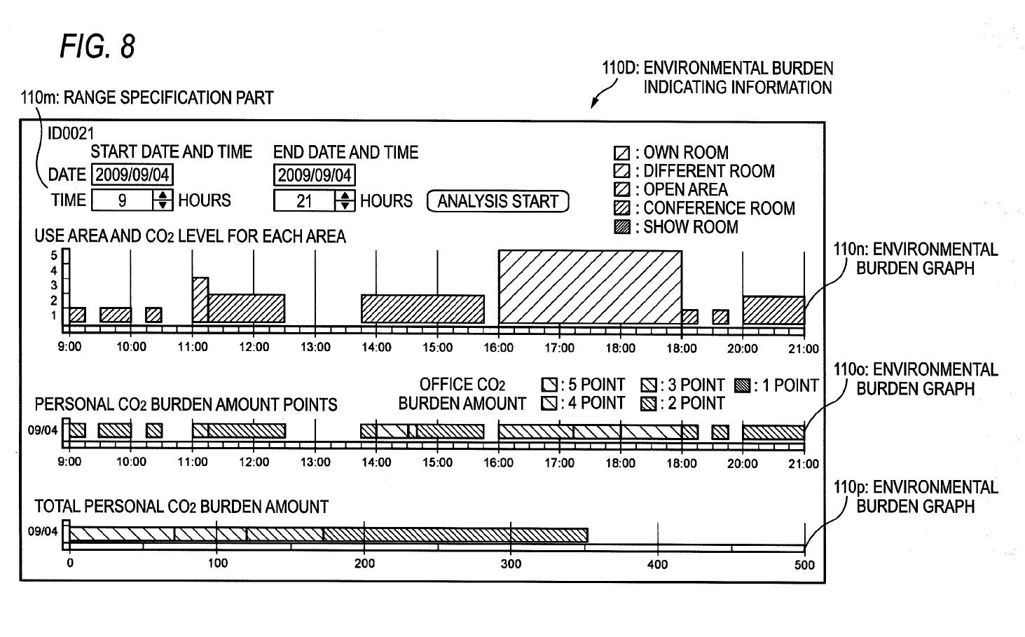

FIG. 8 is a schematic drawing to show a configuration example of environmental burden indicating information 11D. Environmental burden indicating information 11D is image information created to display the environmental burden indicating information 11D on a display section of the terminal device 5 used by user “ID0021,” for example, and has a range specification part 110m and environmental burden graphs 110n to 110p.

The range specification part 110m is an input frame to specify the time period range used for the environmental burden calculation unit 10D to calculate the environmental burden information.

The environmental burden graph 110n is a graph to display the facilities used by user “ID0021” and the environmental burden for each facility as a vertical axis and the time as a horizontal axis. The environmental burden is indicated by a level provided by separating the environmental burden amount into five steps.

The environmental burden graph 110o is a graph to display the personal environmental burden allocated to the user “ID0021” with the time as a horizontal axis. Here, points are a value provided by dividing the level of the environmental burden graph 110n by the number of use persons and allocating to the users.

When a comparison is made between the environmental burden graphs 110n and 110o between 13:45 and 15:45, it is seen that the points change in the environmental burden graph 110o. It indicates that the number of users using the conference room changes with the time and thus the points allocated to the user “ID0021” change. Between 16:00 to 18:00, as another user existing in user “ID0021”'s own room leaves user “ID0021”'s own room because the visitor goes home, etc., the points of the user “ID0021” increase.

The environmental burden graph 110p is a graph to indicate the total points allocated to the user “ID0021.”

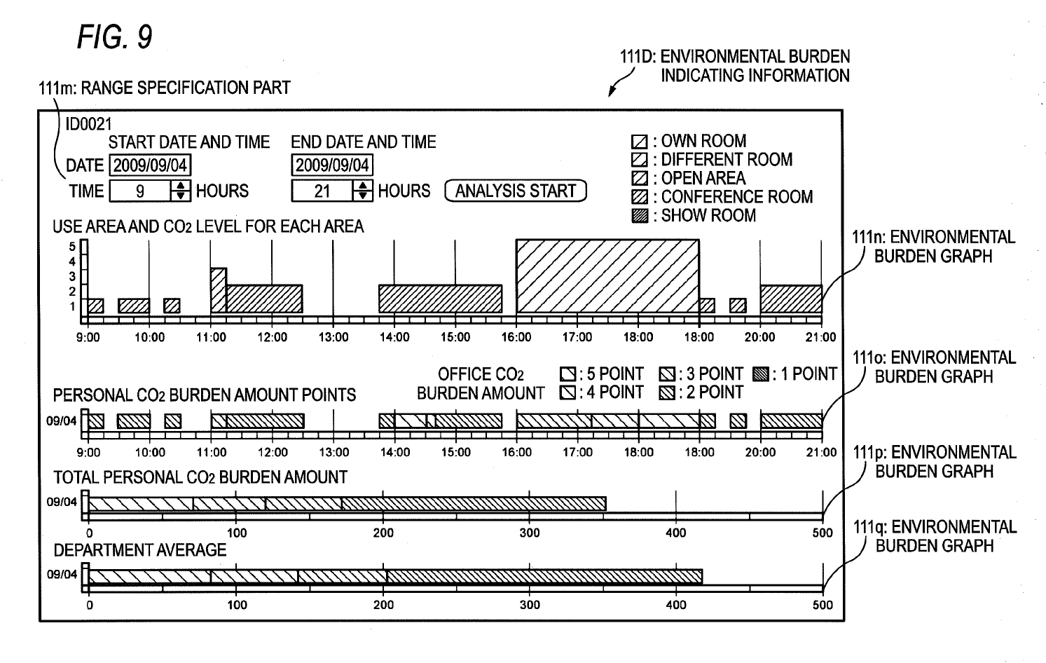

FIG. 9 is a schematic drawing to show a configuration example of environmental burden indicating information 11D. Environmental burden indicating information 11D is image information created to display the environmental burden indicating information 11D on the display section of the terminal device 5 used by user “ID0021,” for example, and has a range specification part 111m and environmental burden graphs 111n to 111p.

The range specification part 111m corresponds to the range specification part 110m shown in FIG. 8. The environmental burden graphs 111n to 111p correspond to the environmental burden graphs 110n to 110p shown in FIG. 8.

An environmental burden graph 111q is a graph to show an average of the totals of the points allocated to the users in department “second sales G” to which the user “ID0021” belongs. The values are provided by acquiring the attributes of the users from the organization attribute information 400 shown in FIG. 6 and referencing the department environmental burden information 111C shown in FIG. 7 and can be compared with the environment burden of the user.

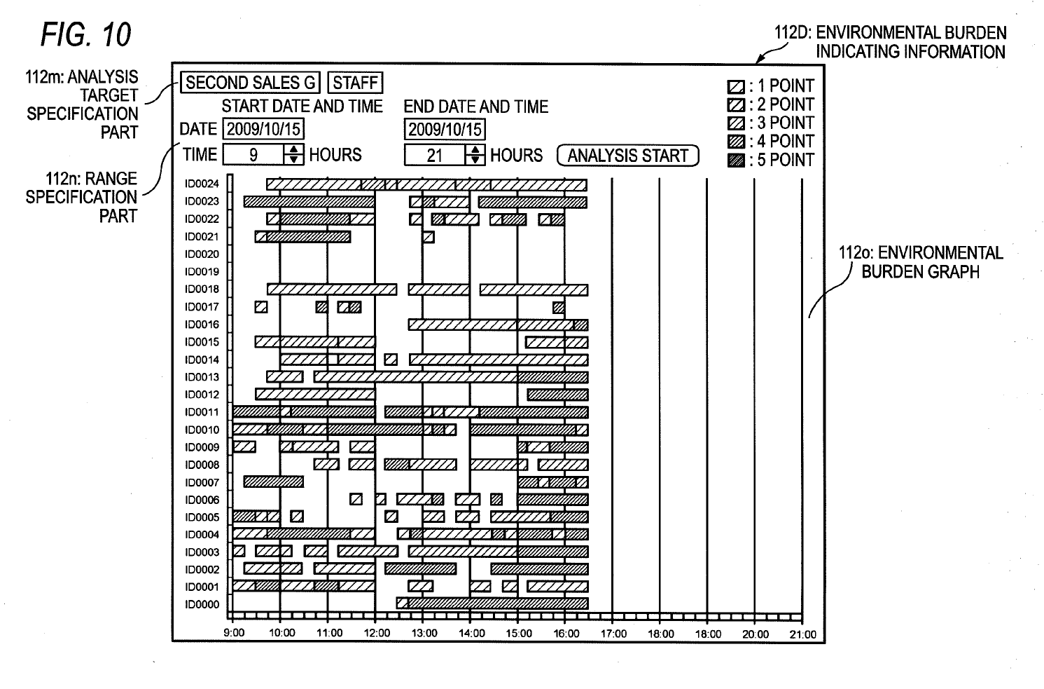

FIG. 10 is a schematic drawing to show a configuration example of environmental burden indicating information 11D. Environmental burden indicating information 112D is image information created to display information provided by totalizing the environmental burden indicating information 11D about job classification “staff” in the department “second sales,” for example, on the display section of the terminal device 5, and has an analysis target specification part 112m, a range specification part 112n, and an environmental burden graph 112o.

The analysis target specification part 112m is an input frame to specify the attribute of each user used for the environmental burden calculation unit 10D to calculate the environmental burden information.

The range specification part 112n is an input frame to specify the time period range used for the environmental burden calculation unit 10D to calculate the environmental burden information.

The environmental burden graph 112o is a graph to display the personal environmental burden amounts allocated to users “ID0000” to “ID0024” of the job classification “staff” in the department “second sales” with the time on a horizontal axis.

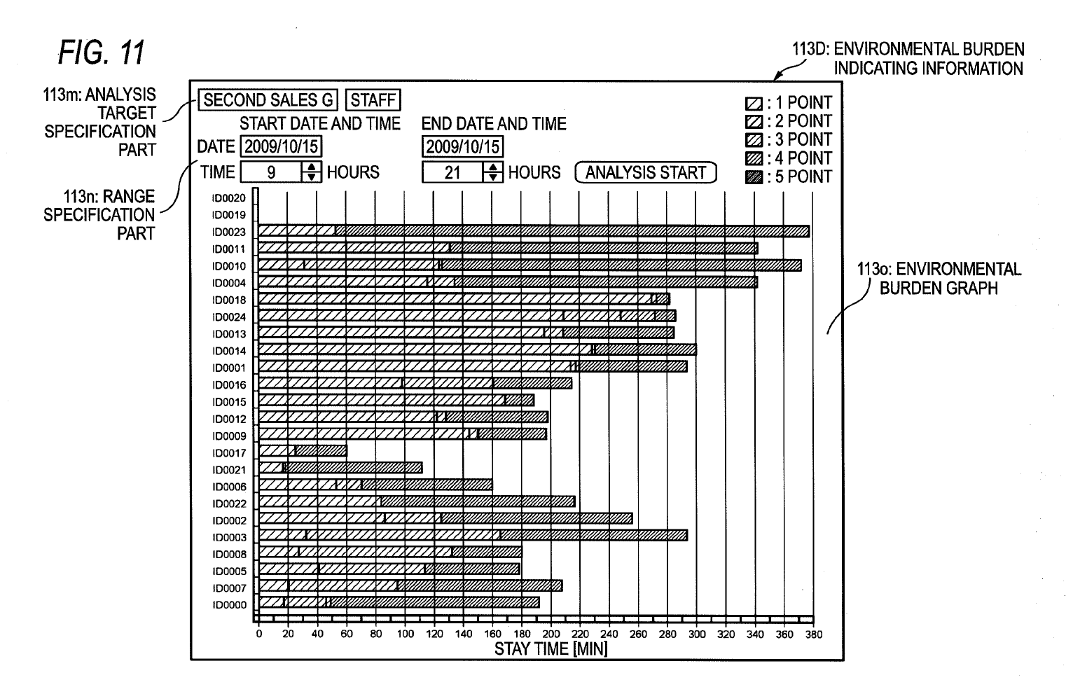

FIG. 11 is a schematic drawing to show a configuration example of environmental burden indicating information 11D.

Environmental burden indicating information 113D is image information created to display information provided by totalizing the environmental burden indicating information 11D about job classification “staff” in the department “second sales,” for example, on the display section of the terminal device 5, and has an analysis target specification part 113m, a range specification part 113n, and an environmental burden graph 113o.

The analysis target specification part 113m is an input frame to specify the attribute of each user used for the environmental burden calculation unit 10D to calculate the environmental burden information.

The range specification part 113n is an input frame to specify the time period range used for the environmental burden calculation unit 10D to calculate the environmental burden information.

The environmental burden graph 113o is a graph to display the totals of the points of the personal environmental burden amounts allocated to the users “ID0000” to “ID0024” of the job classification “staff” in the department “second sales.”

(Operation) The operation of the environmental burden indicating system in the embodiment of the invention will be discussed below with reference to the accompanying drawings:

(Basic operation of environmental burden indicating system) First, when the position detection target person 300a as the user moves in the facilities of the organization and uses each of the facilities 30A to 30H, the position sensor group 30 detects the position of the tag 31a. The position information acquisition server 3 stores a history of positions where the user exists in the position information history DB 3A as the position information history 300A based on the positions detected by the position sensor group 30.

At the same time, the environmental burden information acquisition server 2 acquires the environmental burden amounts of the facilities 30A to 30H from the power consumption amount monitoring device 20A, the lighting consumption amount monitoring device 20B, the air conditioning consumption amount monitoring device 20C, and the terminal device consumption amount monitoring device 20D and stores the amounts in the environmental burden information history DB 2A as the environmental burden information history 200.

The organization attribute information 400 in the organization attribute information DB 4 is previously input by an administrator of the organization.

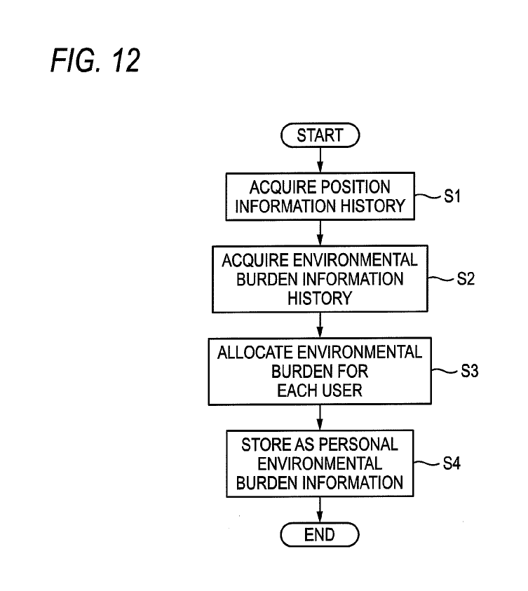

(Generation operation of environmental burden information) FIG. 12 is a flowchart to show an operation example of the environmental burden indicating server 1.

First, the position information history acquisition unit 10A acquires the position information history 300A from the position information history DB 3A at regular time intervals, for example, at intervals of one day or one hour (S1). Next, the environmental burden information history acquisition unit 10B acquires the environmental burden information history 200 from the environmental burden information history DB 2A (S2). Step 2 is executed at the same time as and at the same frequency as step 1.

Next, the environmental burden calculation unit 10D converts the position information history of each user into a history of the facilities used by the user, allocates the environmental burdens of the users using the same facility for each user, and generates personal environmental burden information 11B (S3), and stores the information in the storage section 11 (S4). For example, personal environmental burden information 110B as shown in FIG. 5 is generated and is stored every unit time.

Next, if an indicating request of environmental burden indication information is made by the user or if it becomes necessary to indicate environmental burden indication information to the user, the environmental burden indicating server 1 generates environmental burden indicating information 11D.

The case where an indicating request of environmental burden indication information is made is, for example, the case where the user makes an indicating request through the terminal device 5 or the mobile terminal device 6 or the like.

The case where it becomes necessary to indicate environmental burden indication information to the user is, for example, the case where setting is made so as to indicate the environmental burden indicating information of the user on the display section included in the multiple function device when the user uses the multiple function device 7, the case where setting is made so as to change the timbre of a beep sound in response to the environmental burden amount when the user passes through the entering and leaving gate 8, or the like.

If setting is made so as to transmit environmental burden indicating information through a mail server (not shown) to the mobile terminal device 6 when the environmental burden amount of the user exceeds a predetermined threshold value, environmental burden indicating information 11D may be generated.

The generation operation of the environmental burden indicating information 11D will be discussed below:

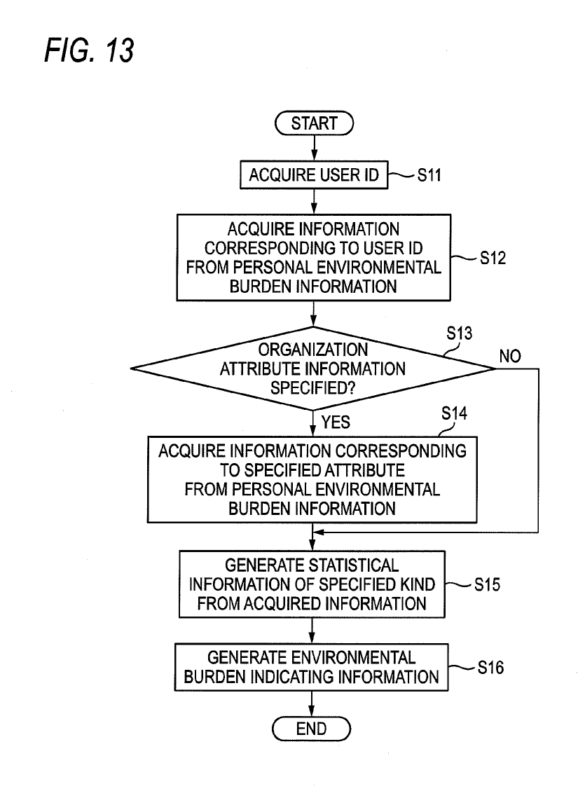

(Generation operation of environmental burden indicating information) FIG. 13 is a flowchart to show another operation example of the environmental burden indicating server 1.

First, the environmental burden calculation unit 10D acquires the ID of the user to whom environmental burden indicating information is to be indicated, for example, “ID0021” (S11). This means that the unit acquires the ID of the user using the terminal device 5, the mobile terminal device 6, or the multiple function device 7 or the ID of the user passing through the entering and leaving gate 8.

Next, the environmental burden calculation unit 10D acquires information corresponding to the user ID acquired from the personal environmental burden information 11B, for example, information corresponding to the user ID “ID0021” from the personal environmental burden information 110B shown in FIG. 5 (S12).

Next, if organization attribute information is further specified from the user to whom environmental burden indicating information is to be indicated (S13; Yes), namely, if an indicating request of not only environmental burden indicating information 110D indicating the personal environmental burden amount shown in FIG. 8, but also environmental burden indicating information 111D to 113D indicating the environmental burden amount of the department and the environmental burden amount of another user in the department as shown in FIGS. 9 to 11, the environmental burden calculation unit 10D acquires information corresponding to the further specified attribute is acquired from the personal environmental burden information 11B (S14). This means that the unit acquires the personal environmental burden information of another user in the department to which that user belongs as required.

Next, the environmental burden calculation unit 10D generates statistical information of the kind specified previously or at the information indicating request time by the user as organization environmental burden information 11C from the acquired information. This is, for example, statistical information of total, average, distribution, etc., of environmental burden points, but may be any other statistical information of variance, deviation, standard deviation, etc.

Next, the environmental burden indicating unit 10E generates environmental burden indicating information 11D of image information of text, a graph, etc., for the terminal device 5, the mobile terminal device 6, and the multiple function device 7 or information to produce a beep sound for the entering and leaving gate 8 from the statistical information of the organization environmental burden information 11C, etc., generated by the environmental burden calculation unit 10D (S16).

The generated environmental burden indicating information 11D is indicated at any of the terminal device 5, the mobile terminal device 6, the multiple function device 7, or the entering and leaving gate 8 used by the user to whom the environmental burden indicating information is to be indicated.

### Other Embodiments

The invention is not limited to the embodiment described above and various modifications may be made without departing from the scope and the spirit of the invention.

For example, it is considered that it is difficult for the user belonging to department “Guest” shown in FIG. 6, for example, the user who acts together with a guest, etc., to limit use of an air conditioner or lighting for the guest and it is severe for one person to bear the environmental burden amount. Thus, considering environmentally sensitive easiness, the level is multiplied by a coefficient of 0.3; for example, if the level of a facility is 3, the environmental load amount of 0.9 points is allocated to the facility. The whole department of the user bears the remaining 3−0.9=2.1 points, etc.

It is assumed that the environmentally sensitive easiness depends on the user's job classification. Thus, the environmentally sensitive easiness of a company officer may be weighted as 0.8, that of a manager may be weighted as 0.7, and that of a person in charge may be weighted as 0.6. The environmentally sensitive easiness of a customer may be weighted as 0.1, that of a partner may be weighted as 0.4, and that of dispatching or outsourcing may be weighted as 0.8.

When inefficient environmental burden exceeding a determined threshold value such as the case where a facility whose environmental burden level is high, for example, a conference room for 30 persons is used by five persons occurs for a determined time period or for determined hours, advice information may be transmitted to the users by mail, etc.

When a facility is used by a plurality of users and then the environmental burden amount of the users remaining in the facility increases as a user leaves and the increase is larger than the assumed increase, it is determined that the leaving user forgets about turning off the air conditioner, the terminal of the leaving user in the facility, etc., and warning information may be transmitted to the mobile terminal, etc., of the user by mail, etc.

As for a facility whose environmental burden can be acknowledged although the facility is not used, the environmental burden amount of the facility may be allocated to the administrator, etc., of the environmental burden indicating system or a message to the effect that fruitless environmental burden exists may be indicated.

The position information history acquisition unit 10A, the environmental burden information history acquisition unit 10B, the organization attribute information acquisition unit 10C, the environmental burden calculation unit 10D, and the environmental burden indicating unit 10E used in the embodiment may be read from a storage medium of a CD-ROM, etc., to the storage section in the apparatus or may be downloaded from a server, etc., connected to the network of the Internet, etc., into the storage section in the apparatus. Some or all of the units used in the embodiment may be implemented as hardware of an ASIC, etc.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An environmental burden indicating apparatus comprising:
a first history acquiring unit that acquires history of positional information which indicates position of at least one user, wherein the history of the positional information corresponds to first time information;
a second history acquiring unit that acquires history of environmental burden information which indicates the amount of burden against an environment produced in a facility where the at least one user is positioned, wherein the history of the environmental burden information corresponds to second time information;
a environmental burden calculation unit that calculates personal environmental burden information of each user after allocating the environmental burden information acquired from the facility into each user based on one or more of the positional information, the first time information and second time information; and
a environmental burden indicator unit that indicates the personal environmental burden information of the at least one user.

2. The environmental burden indicating apparatus according to claim 1 further comprising:
an attribute information acquiring unit that acquires organization attribute information to which organization the at least one user belongs,
wherein the calculation unit specifies, from the acquired organization attribute information, at least one common attribute that the at least one user and another user have in common and generates organization environmental burden information by acquiring personal environmental burden information of the another user.

3. The environmental burden indicating apparatus according to claim 2, wherein the indicating unit indicates combined environmental burden information which is generated based on the personal environmental burden information and the organization environmental burden information.

4. The environmental burden indicating apparatus according to claim 2, wherein the calculation unit changes, based on the organization attribute information of the at least one user, an allocated personal environmental burden information of another user who is positioned in the same facility as the at least selected user.

5. The environmental burden indicating apparatus according to claim 1, wherein the indicating unit indicates information when the personal environmental burden information exceeds one or more designated thresholds.

6. The environmental burden indicating apparatus according to claim 1, wherein the indicating unit indicates the personal environmental burden information along a time line.

7. The environmental burden indicating apparatus according to claim 1, wherein the indicating unit indicates the personal environmental burden by accumulating the personal environmental burden information in the facility of the at least one user.

8. A non-transitory computer readable medium storing a computer readable program executable by a computer for causing a computer to execute a process for indicating environmental burden, the process comprising:
acquiring history of positional information which indicates position of at least one user, wherein the history of the positional information corresponds to first time information;
acquiring history of environmental burden information which indicates the amount of burden against environment produced in a facility where the at least one user is positioned, wherein the history of the environmental burden information corresponds to second time information;
allocating the environmental burden information acquired from the facility into each user based on one or more of the positional information, the first time information and second time information;
calculating personal environmental burden information of each user from the allocated environmental burden information; and
indicating the personal environmental burden information of at least one selected user.
